(19) United States
(12) Patent Application Publication
(10) Pub. No.: US 2025/0363226 A1
(43) Pub. Date: Nov. 27, 2025

(54) SYSTEMS AND METHODS FOR TRANSFERRING PERSONALIZED MACHINE LEARNING (ML)/ARTIFICIAL INTELLIGENCE (AI) MODELS AND DATA

(71) Applicant: Affle (India) Limited, India, Gurugram (IN)

(72) Inventors: Anuj Khanna SOHUM, Singapore (SG); Charles Yong Jien FOONG, Templestowe (AU); Madhusudana RAMAKRISHNA, Singapore (SG)

(73) Assignee: Affle (India) Limited, India, Gurugram (IN)

(21) Appl. No.: 19/216,206

(22) Filed: May 22, 2025

(30) Foreign Application Priority Data
May 22, 2024 (IN) 202311079233

(51) Int. Cl. G06F 21/60; G06F 18/241

(52) U.S. Cl. CPC G06F 21/602; G06F 18/241

(57) ABSTRACT

The present invention discloses a method for transferring data from one storage to another storage. The method includes identifying one or more Machine Learning (ML)/Artificial Intelligence (AI) models and data associated with the one or more ML/AI models to be transferred to the other storage selected by the transfer AI agent. The method includes organizing the one or more ML/AI models and data to be transferred to the other storage. The method includes abstracting relevant information from the one or more ML/AI models and the data. The relevant information is encrypted. The method includes applying one or more obfuscation techniques on the encrypted relevant information. The encrypted relevant information is transferred to the other storage.

### CROSS-REFERENCE TO RELATED APPLICATIONS

This patent application claims priority to Indian Patent Application No. IN 202311079233, filed May 22, 2024, entitled “SYSTEMS AND METHODS FOR TRANSFERRING PERSONALIZED MACHINE LEARNING (ML)/ARTIFICIAL INTELLIGENCE (AI) MODELS AND DATA,” and assigned to the assignee hereof. The disclosure of the prior application is considered part of and is incorporated by reference in this patent application.

### TECHNICAL FIELD

Embodiments of the present disclosure generally relate to artificial intelligence (AI) based systems and more particularly to systems and methods for transferring personalized machine learning (ML)/artificial intelligence (AI) models and data.

### BACKGROUND

In the age of rapidly advancing technology and the proliferation of personalized machine learning models, the efficient and secure transfer of these models and associated data has become a significant challenge. Personalized machine learning models are designed to provide tailored predictions and decisions, catering to specific individuals or use cases. As the demand for these personalized models continues to grow, there is an increasing need for a structured and secure framework to facilitate their transfer and management.

One fundamental aspect of this challenge lies in the organization and hosting of content. To ensure the easy transfer of personalized machine learning models and data, it is imperative that these assets are hosted in a structured and organized manner. Such structured hosting not only allows for efficient access but also enables seamless movement of data between different locations or devices. Another critical aspect involves data abstraction from these learning models. Data abstraction involves the extraction of pertinent information from these models, which can serve a variety of purposes, including retraining, backup, or secure transfer.

Consequently, there is a need for improved systems and methods for transferring personalized machine learning (ML)/artificial intelligence (AI) models and data, to address at least the aforementioned issues of the prior arts.

### OBJECTS OF THE INVENTION

A general objective of the present disclosure is to provide a system and a method for transferring data from one location to another in a system. The further objectives of present disclosure are discussed below.

Another objective of the present disclosure is to provide a system configured to obfuscate data prior to transferring the data.

Another objective of the present subject matter is to encrypt the data to safeguard data from attacks, prior to being transferred.

### SUMMARY OF THE INVENTION

Solution to one or more drawbacks of existing technology, and additional advantages are provided through the present subject matter. Additional features and advantages are realized through the technicalities of the present subject matter. Other embodiments and aspects of the subject matter are described in detail herein and are considered to be a part of the claimed subject matter.

In an embodiment, the present invention discloses a method for transferring data from one storage to another storage. The method includes identifying, by a transfer AI agent, one or more Machine Learning (ML)/Artificial Intelligence (AI) models and data associated with the one or more ML/AI models to be transferred to the other storage selected by the transfer AI agent. The method includes organizing, by the transfer AI agent, the one or more ML/AI models and data to be transferred to the other storage. The method includes abstracting, by the transfer AI agent, relevant information from the one or more ML/AI models and the data. The relevant information is encrypted. The method includes applying, by the transfer AI agent, one or more obfuscation techniques on the encrypted relevant information. The encrypted relevant information is transferred to the other storage.

In an embodiment, the present invention discloses a system for transferring data from one storage to another storage. The system includes a transfer AI agent configured to identify one or more Machine Learning (ML)/Artificial Intelligence (AI) models and data associated with the one or more ML/AI models to be transferred to the other storage selected by the transfer AI agent. The transfer AI agent is configured to organize the one or more ML/AI models and data to be transferred to the other storage. The transfer AI agent is configured to abstract relevant information from the one or more ML/AI models and the data. The relevant information is encrypted. The transfer AI agent is further configured to apply one or more obfuscation techniques on the encrypted relevant information. The encrypted relevant information is transferred to the other storage.

### BRIEF DESCRIPTION OF THE DRAWINGS

The disclosure will be described and explained with additional specificity and detail with the accompanying figures in which:

FIG. 1 illustrates an exemplary block diagram representation of a network architecture implementing a system for transferring personalized machine learning (ML)/artificial intelligence (AI) models and data, in accordance with an embodiment of the present disclosure;

FIG. 2 illustrates an exemplary block diagram representation of a computer implemented system, such as those shown in FIG. 1, capable of transferring personalized machine learning (ML)/artificial intelligence (AI) models and data, in accordance with an embodiment of the present disclosure; and

FIG. 3 illustrates an exemplary flow diagram representation of interaction of transfer AI agents for transferring of personalized ML/AI models and data, in accordance with an embodiment of the present disclosure; and

FIG. 4 illustrates an operational flow diagram depicting a method for transferring data from one location to another, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Embodiments of the present disclosure provide systems and methods for transferring personalized machine learning (ML)/artificial intelligence (AI) models and data.

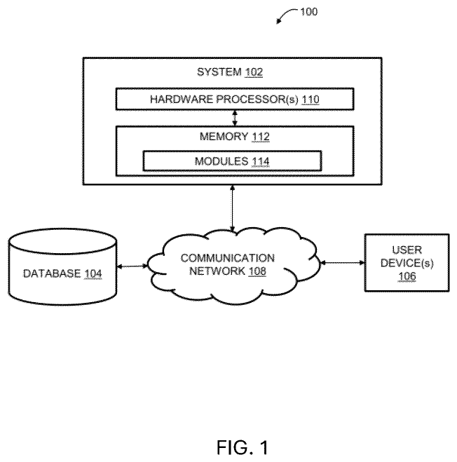

Referring now to the drawings, and more particularly to FIG. 1 through FIG. 3, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 implementing a system for transferring personalized machine learning (ML)/artificial intelligence (AI) models and data, in accordance with an embodiment of the present disclosure. According to FIG. 1, the network architecture 100 includes the system 102, a database 104, and one or more user devices 106. The one or more user devices 106 may be associated with one or more users, and communicatively coupled to the system 102 via a communication network 108. In an exemplary embodiment of the present disclosure, the user devices 106 may include a laptop computer, desktop computer, tablet computer, smartphone, wearable device, a digital camera, and the like. Further, the communication network 108 may be a wired network or a wireless network. The system 102 may be at least one of, but not limited to, a central server, a cloud server, a remote server, an electronic device, a portable device, and the like. Further, the system 102 may be communicatively coupled to the database 104, via the communication network 108. The database 104 may include, but is not limited to, personal data, health data, lifestyle data, finance data, device data, any other data, and combinations thereof. The database 104 may be any kind of databases/repositories such as, but are not limited to, relational database, dedicated database, dynamic database, monetized database, scalable database, cloud database, distributed database, any other database, and combination thereof.

Further, the user device 106 may be associated with, but not limited to, a user, an individual, an administrator, a vendor, a technician, a worker, a specialist, a healthcare worker, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for transferring personalized machine learning (ML)/artificial intelligence (AI) models and data needs. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for transferring personalized machine learning (ML)/artificial intelligence (AI) models and data. Execution of the machine-readable program instructions by the hardware processor 110 may enable the proposed system 102 to transfer personalized machine learning (ML)/artificial intelligence (AI) models and data. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, sensors, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may transfer from one location to another, one or more personalized machine learning (ML)/artificial intelligence (AI) models and/or data specifically trained for making predictions tailored to individual users or specific use cases.

In an exemplary embodiment, the system 102 may enable structured hosting and transfer of personalized ML/AJ models. The structured manner of hosting content may include storing personalized machine learning models and data in a structured and organized manner, facilitating efficient access and transfer of the data. The meticulous manner in which the transfer AI agent (302) prepares, categorizes, and structures data potentially originating from multiple user devices or diverse interaction sources-before its placement into segregated storage instances (e.g., 304-1 to 304-N) within the secure enclave, is intentionally designed to facilitate subsequent privacy-preserving federated operations. The organized data structure, as curated by the transfer AI agent, can inherently support advanced, privacy-enhancing techniques such as federated learning or combined analytics across these distributed datasets. This allows for the derivation of collective intelligence or broader insights from multiple user data sources without the need for co-mingling raw personal data, thereby robustly upholding user privacy while enabling valuable multi-source AI operations within the secure confines of the enclave.

In an exemplary embodiment, the system 102 may perform data abstraction and utilization in ML/AI models. The data abstraction from ML/AI models may include extracting relevant information from machine learning models, allowing for purposes such as retraining, backup, and secure transfer.

In an exemplary embodiment, the system 102 may securely store the AI/ML models and/or data in a storage, and transfer of AI/ML model data. Storing machine learning model data securely on local devices, ensuring confidentiality and protection against unauthorized access. Further, encrypted server storage may storing a copy of AI/ML model data on a server in an encrypted form, safeguarding the data during transfer and storage.

In an exemplary embodiment, the system 102 may perform data obfuscation to ensure privacy and security. Data obfuscation to prevent third-party generation may include intentionally making AI/ML model data unclear or unintelligible, preventing third parties from generating or deducing sensitive information, thereby enhancing privacy and security during transfer and storage processes.

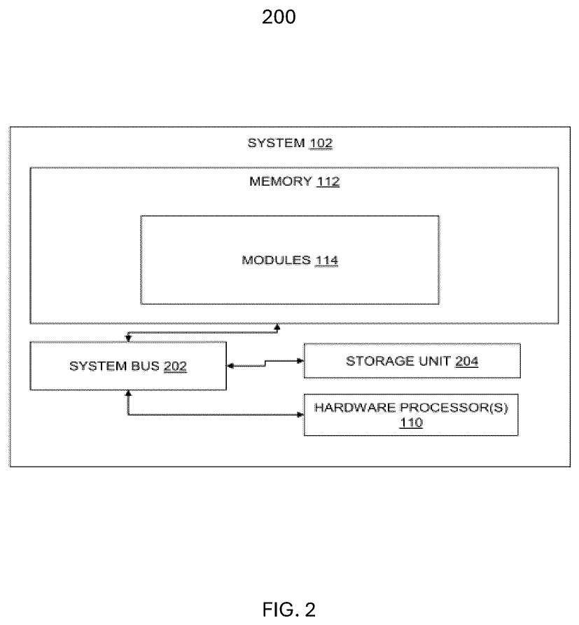

FIG. 2 illustrates an exemplary block diagram representation of a computer implemented system 102, such as those shown in FIG. 1, capable of transferring personalized machine learning (ML)/artificial intelligence (AI) models and data, in accordance with an embodiment of the present disclosure. The system 102 may also function as a computer-implemented system/server (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

The one or more hardware processors 110, as used herein, means any type of computational circuit, such as, but not limited to, a microprocessor unit, microcontroller, complex instruction set computing exceptionally long processor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a repository such as those shown in FIG. 1. The storage unit 204 may store, but is not limited to, telemetry signals, alerts, operations, health status, any other data, and combinations thereof. The storage unit 204 may be any kind of databases/repositories such as, but are not limited to, relational database, dedicated database, dynamic database, monetized database, scalable database, cloud database, distributed database, any other database, and combination thereof.

Furthermore, the other storage (e.g., 304-N) can be integral to a secure cloud-based enclave. The secure cloud-based enclave is not merely a passive repository but is architected as a trusted operational environment wherein authorized AI modules can further process the transferred, categorized, and consolidated AI/ML models and data. Key functionalities within this enclave include the generation of new inferences through the analysis of stored facts, existing inferences, and behavioral patterns accumulated over time, as well as performing further consolidations to refine data and dynamically update user or model profiles. A critical aspect of the system is the capability to store detailed information, including all categorized data (facts, inferences, behaviors), for every significant agent engagement. This practice cultivates a rich historical record within the secure cloud-based enclave, which is paramount for continuous agent learning, dynamic evolution, and, significantly, for ensuring the portability of an AI agent's complete intelligence by meticulously preserving its entire operational history and learned knowledge base.

In an exemplary embodiment, the plurality of modules 114 may transfer from one location to another, one or more personalized machine learning (ML)/artificial intelligence (AI) models and/or data specifically trained for making predictions tailored to individual users or specific use cases.

In an exemplary embodiment, the plurality of modules 114 may enable structured hosting and transfer of personalized ML/AI models. The structured manner of hosting content may include storing personalized machine learning models and data in a structured and organized manner, facilitating efficient access and transfer of the data.

In an exemplary embodiment, the plurality of modules 114 may perform data abstraction and utilization in ML/AI models. The data abstraction from ML/AI models may include extracting relevant information from machine learning models, allowing for purposes such as retraining, backup, and secure transfer.

In an exemplary embodiment, the plurality of modules 114 may securely store the AI/ML models and/or data in a storage, and transfer of AI/ML model data. Storing machine learning model data securely on local devices, ensuring confidentiality and protection against unauthorized access. Further, encrypted server storage may storing a copy of AI/ML model data on a server in an encrypted form, safeguarding the data during transfer and storage.

In an exemplary embodiment, the plurality of modules 114 may perform data obfuscation to ensure privacy and security. Data obfuscation to prevent third-party generation may include intentionally making AI/ML model data unclear or unintelligible, preventing third parties from generating or deducing sensitive information, thereby enhancing privacy and security during transfer and storage processes.

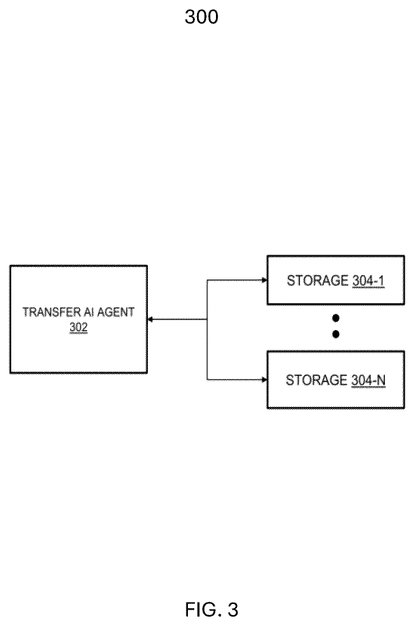

FIG. 3 illustrates an exemplary flow diagram representation of interaction of transfer AI agents for transferring of personalized ML/AI models and data, in accordance with an embodiment of the present disclosure.

For example, the transfer AI agent 302 may be an artificial intelligence system designed to efficiently move data from one location to another while maintaining data integrity, security, and privacy. The transfer AI agent 302 may particularly valuable when handling the transfer of various types of data, including documents, artificial intelligence (AI) models and/or machine learning (ML) models, databases, and more. The transfer AI agent 302 may ensure that data is organized in a structured manner to enable easy access and transfer, abstracts relevant information when necessary, and applies security measures such as encryption to protect data during transit. Moreover, the transfer AI agent 302 employs data obfuscation techniques to make data unintelligible to unauthorized parties, safeguarding sensitive information. The transfer AI agent 302 maintains detailed logs of the transfer process for monitoring, auditing, and troubleshooting purposes.

In an embodiment, information stored can be transferred partially or for a specific purpose. For example, a celebrity/brand/service can share their information for an advertisement, which has a defined scope and duration.

In an embodiment, models that are shared can be language, 3d model, image model, 3d mannerisms, voice, including tonal voices. These models can also be specific models with different engagements, like to a friend, family, co-worker, public, etc. . . .

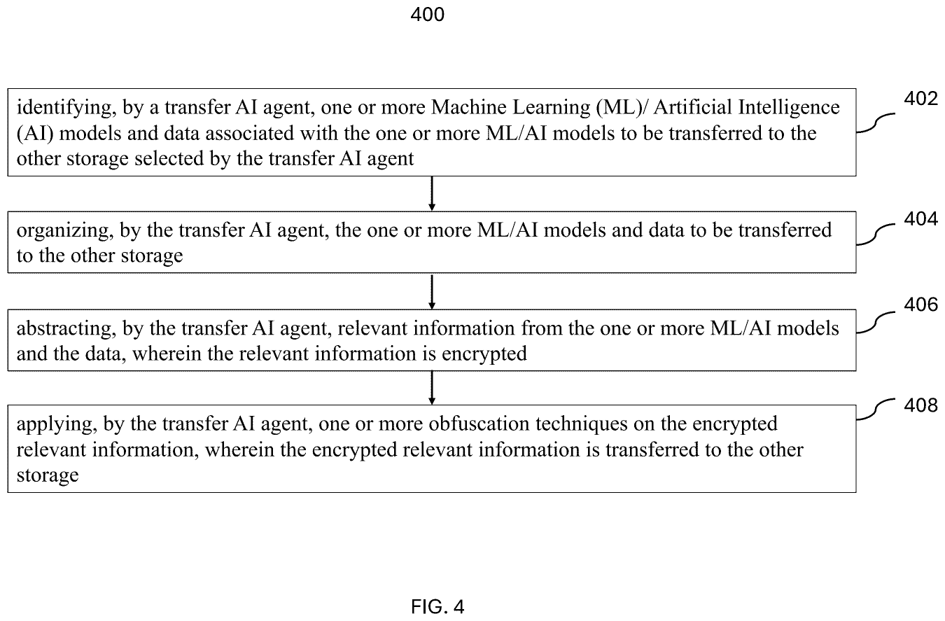

FIG. 4 illustrates an operational flow diagram depicting a method 400 for transferring data from one storage 304-1 to another storage 304-N, in accordance with an embodiment of the present disclosure. The storage 304-1 and the other storage 304-N are present in one system.

At step 402, the method 400 includes identifying, by a transfer AI agent 302, one or more Machine Learning (ML)/Artificial Intelligence (AI) models and data associated with the one or more ML/AI models to be transferred to the other storage 304-N selected by the transfer AI agent 302. The one or more ML/AI models is one or more of a language model, a 3-Dimensional (3D) model, an image model, 3D mannerisms, a voice model including tonal voices. Particularly for personalized AI/ML models that embody or are inextricably linked to unique identity characteristics defining an agent's persona (such as specific voice tones, learned mannerisms, or other distinguishing biometric-like attributes), the transfer AI agent (302) is configured for the secure binding and migration of these intrinsic agent identity attributes. This process includes securely verifying and cryptographically binding these defining characteristics to the model/data package during the transfer. It ensures the immutable and verifiable conveyance of these identity markers to the other storage (304-N), thereby safeguarding against agent impersonation or the stripping of the personalized agent's unique and verifiable identity. The data includes one or more documents, information associated with one or more artificial intelligence (AI) models and/or one or more machine learning (ML) models trained for making predictions tailored to individual users or specific use cases, one or more user interactions with the one or more ML/AI models, learned knowledge based on the one or more user interaction, and one or more databases

At step 404, the method 400 includes organizing, by the transfer AI agent 302, the one or more ML/AI models and data to be transferred to the other storage 304-N. organizing the one or more ML/AI models and the data categorizing the one or more ML/AI models and the data into a plurality of categories. The plurality of categories includes one or more facts having immutable data points representing specific events or user attributes, one or more inferences derived by one or more AI agents based on factual data and an observed behavior, one or more patterns and tendencies observed from one or more user interactions with one or more systems or the one or more AI agents. Organizing further includes structuring the one or more ML/AI models and the data based on the plurality of categories. The system 102 may further employ dynamic categorization, allowing for a refinement of existing categories or the determination of new categories based on evolving data types or novel forms of AI agent interactions. This ensures the categorization schema remains adaptive, comprehensive, and accurately reflects the nuances of the data being managed.

At step 406, the method 400 includes abstracting, by the transfer AI agent 302, relevant information from the one or more ML/AI models and the data, wherein the relevant information is encrypted. Abstracting the data includes retaining sensitive information from the one or more ML/AI models and the data for the transfer to minimize one or more attack surfaces in the one or more ML/AI models and the data during the transfer. The abstraction process executed by the transfer AI agent (302) is purpose-driven and highly selective. The abstraction involves intelligently discerning and extracting specific features, parameters, or data segments that are not only relevant for minimizing attack surfaces but are also essential for defined future uses within the destination storage or secure enclave. Such uses can include, but are not limited to, model retraining, new inference generation, or enabling specific AI-driven functionalities. Thus, the abstraction aims to optimize the structure and content of the stored data for efficient and effective utilization by other AI modules operating within the secure enclave, balancing security with utility.

At step 408, the method 400 includes applying, by the transfer AI agent 302, one or more obfuscation techniques on the encrypted relevant information. The encrypted relevant information is transferred to the other storage 304-N. The one or more obfuscation techniques includes intentionally making the data unintelligible, preventing third parties from one or more of generating sensitive information and deducing sensitive information. The application of the one or more obfuscation techniques by the transfer AI agent (302) can be contextual and multi-layered which involves applying potentially different levels, types, or strengths of obfuscation to different categories of data (e.g., Facts, Inferences, Behaviour) or even to specific sensitive model parameters, based on their assessed sensitivity, the context of the transfer, or their intended use within the secure enclave. Moreover, such obfuscation techniques may be designed for enclave-specific reversibility, ensuring that the obfuscated data, while protected during transit and in general storage, can only be rendered fully intelligible (de-obfuscated) using specific keys or methods that are intrinsically linked to, and managed by, the security protocols of the trusted destination storage or secure cloud enclave. Obfuscating ensures that the full utility of the data is unlocked exclusively within the authorized and secure operational environment. The one or more ML/AI models and the data is transferred via a secure channel, further wherein the secure channel is HTTPS with MTLS. Further, prior to transferring the one or more ML/AI models and the data, the method 400 includes performing, by the transfer AI agent 302, a validation check on the one or more ML/AI models and the data to ensure that the one or more ML/AI models and the data is not corrupted, and the one or more ML/AI models and the data is meeting a predefined standard prior to the transfer, and packaging the one or more ML/AI models and the data with metadata/scripts facilitating one or more of an immediate fine-tuning, a subsequent fine-tuning, and a training to be done during the transfer of the data. Prior to transferring the one or more ML/AI models, the method 400 also includes merging one or more common data points in the one or more ML/AI models and the data originating from a plurality of interactions between a user and one or more AI agents, and aggregating behavioural data from one or more touchpoints to form a holistic view of the data prior to the transfer of the one or more ML/AI models and the data.

Furthermore, prior to the final commitment of the AI/ML models and associated data to the other storage (304-N), the transfer AI agent (302) may perform a uniqueness or duplication assessment. The uniqueness or duplication assessment may involve interfacing with a central manifest, a marketplace registry, or a similar inventory system to ascertain if the personalized agent or its core data is substantially a duplicate of an existing asset, thereby preventing redundant transfers and optimizing storage resources.

In accordance with an embodiment of the present disclosure, the method 400 further includes updating, by the transfer AI agent 302, a user profile associated with a user by collecting one or more new data points from a plurality of AI agents interacting with the user. The one or more new data points is categorized into the plurality of categories. Moving forward, the method 400 also includes maintaining, by the transfer AI agent 302, one or more detailed logs corresponding to a transfer of the one or more ML/AI models and the data for monitoring the one or more ML/AI models and the data, auditing the one or more ML/AI models and the data, and troubleshooting.

A primary objective of the disclosed systems and methods is to achieve robust AI agent portability and comprehensive information persistence, ensuring an agent's intelligence is not lost during transfers or migrations. This is facilitated by a systematic capture of not only the one or more ML/AI models and their associated categorized data (facts, inferences, observed behaviors), but critically, also the explicit or implicit user validation or feedback pertaining to the agent's inferences, predictions, or actions. Such feedback is vital for refining the agent's understanding and confirming the accuracy of its learned knowledge. Moreover, the system is architected to capture, store, and manage the temporal evolution of user data, preferences, and interaction patterns, recognizing that user interests and behaviors can shift over time (e.g., an earlier preference for one topic might evolve into an interest in another). This comprehensive and dynamic capture of an agent's entire operational context—encompassing its models, learned parameters, categorized historical interactions with corresponding user validations, and their temporal changes—allows the agent to be instantiated or migrated to new devices, platforms, or updated versions without the loss of its acquired intelligence, personalization depth, or longitudinal understanding. This effectively mitigates the ‘cold start’ problem often encountered in agent transitions and preserves the agent's true, evolving learned intelligence.

### Exemplary Interaction Process Between AI Agents:

In this interaction, the transfer AI agent 302 may be a central component responsible for transferring data to multiple storage systems such as a storage 304-1 to storage 304-N, collectively denoted as storage 304. The transfer AI agent 302 may initiate the process by identifying the data to be transferred, selecting the appropriate storage systems, and ensuring that the data is structured for efficient transfer. It abstracts relevant information from learning models, applies encryption for secure storage, and employs data obfuscation techniques to protect data privacy. Each storage system receives the data in an organized and secure manner. The role of the transfer AI agent 302 may encompass data integrity, security, and the safeguarding of sensitive information. Throughout the interaction, it maintains records and reports for monitoring and auditing purposes, ensuring a seamless and secure transfer of data to multiple storage locations.

### Exemplary Scenario 1:

In an exemplary scenario, the transfer AI agent 302 may be deployed by a healthcare provider during the migration of patient data from an older electronic health record (EHR) system to a modern EHR. The transfer AI agent 302 may abstract relevant patient records from the old system and organizes them in a structured format compatible with the new EHR. To ensure data security, the transfer AI agent 302 applies encryption during transfer and further safeguards patient privacy through data obfuscation techniques. This not only prevents unauthorized access but also protects sensitive patient information. The transfer AI agent 302 efficiently manages the transfer, allowing the data to seamlessly integrate into the new system. Throughout the process, the transfer AI agent 302 maintains comprehensive logs for auditing and quality control. The scenario underscores the essential role of the transfer AI agent 302 in safeguarding data integrity and privacy, particularly in critical domains like healthcare, where patient data security is paramount.

### Exemplary Scenario 2:

Consider a scenario, a technology company, “TechX,” employs the transfer AI agent 302 to facilitate the secure transfer of personalized AI/ML models to their clients. The process begins with the transfer AI agent 302 structuring the model data and abstracting relevant components, ensuring that sensitive information is retained. Security measures, including encryption, are applied to safeguard the model during transfer, and data obfuscation techniques are used to protect proprietary information. The transfer AI agent 302 initiates the transfer, and upon receiving the data, the client, “ClientY,” verifies its successful integration into their systems. Comprehensive logs are maintained for auditing and quality control. This scenario exemplifies how advanced AI agents enable secure and efficient data transfer, empowering clients with valuable machine learning models while maintaining data integrity and confidentiality.

For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform. As illustrated, the hardware platform may include additional components not shown, and some of the components described may be removed and/or modified. For example, a computer system with multiple GPUs may be located on external-cloud platforms including Amazon Web Services® (AWS), internal corporate cloud computing clusters, or organizational computing resources.

The hardware platform may be a computer system such as the system 102 that may be used with the embodiments described herein. The computer system may represent a computational platform that includes components that may be in a server or another computer system. The computer system may be executed by the processor (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor that executes software instructions or code stored on a non-transitory computer-readable storage medium to perform methods of the present disclosure. The software code includes, for example, instructions to gather data and analyze the data as the plurality of modules 114.

The instructions on the computer-readable storage medium are read and stored the instructions in storage or random-access memory (RAM). The storage may provide a space for keeping static data where at least some instructions could be stored for later execution. The stored instructions may be further compiled to generate other representations of the instructions and dynamically stored in the RAM such as RAM. The processor may read instructions from the RAM and perform actions as instructed.

The computer system may further include the output device to provide at least some of the results of the execution as output including, but not limited to, visual information to users, such as external agents. The output device may include a display on computing devices and virtual reality glasses. For example, the display may be a mobile phone screen or a laptop screen. GUIs and/or text may be presented as an output on the display screen. The computer system may further include an input device to provide a user or another device with mechanisms for entering data and/or otherwise interacting with the computer system. The input device may include, for example, a keyboard, a keypad, a mouse, or a touchscreen. Each of these output devices and input devices may be joined by one or more additional peripherals. For example, the output device may be used to display the results such as bot responses by the executable chatbot.

A network communicator may be provided to connect the computer system to a network and in turn to other devices connected to the network including other clients, servers, data stores, and interfaces, for example. A network communicator may include, for example, a network adapter such as a LAN adapter or a wireless adapter. The computer system may include a data source interface to access the data source. The data source may be an information resource. As an example, a database of exceptions and rules may be provided as the data source. Moreover, knowledge repositories and curated data may be other examples of the data source.

Embodiments of the present disclosure provide systems and methods for transferring personalized machine learning (ML)/artificial intelligence (AI) models and data. The present disclosure empowers organizations to deliver enhanced personalization in various applications, leading to improved user experiences and more accurate predictions. The efficiency of the transfer process not only saves time and resources but also enhances the security of sensitive data by employing encryption and obfuscation techniques. This, in turn, safeguards information, reducing the risk of unauthorized access or replication.

The written description describes the subject matter herein to enable any person skilled in the art to make and use the embodiments. The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

We claim:

1. A method for transferring data from one storage to another storage, comprising:
identifying, by a transfer AI agent, one or more Machine Learning (ML)/Artificial Intelligence (AI) models and data associated with the one or more ML/AI models to be transferred to the other storage selected by the transfer AI agent;
organizing, by the transfer AI agent, the one or more ML/AI models and data to be transferred to the other storage;
abstracting, by the transfer AI agent, relevant information from the one or more ML/AI models and the data, wherein the relevant information is encrypted; and
applying, by the transfer AI agent, one or more obfuscation techniques on the encrypted relevant information, wherein the encrypted relevant information is transferred to the other storage.

2. The method according to claim 1, wherein the one or more obfuscation techniques comprises intentionally making the data unintelligible, preventing third parties from one or more of generating sensitive information and deducing sensitive information.

3. The method according to claim 1, further comprising:
maintaining, by the transfer AI agent, one or more detailed logs corresponding to a transfer of the one or more ML/AI models and the data for monitoring the one or more ML/AI models and the data, auditing the one or more ML/AI models and the data, and troubleshooting.

4. The method according to claim 1, wherein the one or more ML/AI models is one or more of a language model, a 3-Dimensional (3D) model, an image model, 3D mannerisms, a voice model including tonal voices and the data comprises one or more documents, information associated with one or more artificial intelligence (AI) models and/or one or more machine learning (ML) models trained for making predictions tailored to individual users or specific use cases, one or more user interactions with the one or more ML/AI models, learned knowledge based on the one or more user interaction, and one or more databases.

5. The method according to claim 1, wherein organizing the one or more ML/AI models and the data comprises:
categorizing the one or more ML/AI models and the data into a plurality of categories, further wherein the plurality of categories comprises one or more facts having immutable data points representing specific events or user attributes, one or more inferences derived by one or more AI agents based on factual data and an observed behaviour, one or more patterns and tendencies observed from one or more user interactions with one or more system (102)s or the one or more AI agents; and
structuring the one or more ML/AI models and the data based on the plurality of categories.

6. The method according to claim 1, wherein abstracting the data comprises retaining sensitive information from the one or more ML/AI models and the data for the transfer to minimize one or more attack surfaces in the one or more ML/AI models and the data during the transfer.

7. The method according to claim 1, further comprising:
merging one or more common data points in the one or more ML/AI models and the data originating from a plurality of interactions between a user and one or more AI agents; and
aggregating behavioral data from one or more touchpoints to form a holistic view of the data prior to the transfer of the one or more ML/AI models and the data.

8. The method according to claim 1, further comprising:
updating, by the transfer AI agent, a user profile associated with a user by collecting one or more new data points from a plurality of AI agents interacting with the user, wherein the one or more new data points is categorized into a plurality of categories.

9. The method according to claim 1, further comprising:
performing, by the transfer AI agent, a validation check on the one or more ML/AI models and the data to ensure that the one or more ML/AI models and the data is not corrupted, and the one or more ML/AI models and the data is meeting a predefined standard prior to the transfer; and
packaging the one or more ML/AI models and the data with metadata/scripts facilitating one or more of an immediate fine-tuning, a subsequent fine-tuning, and a training to be done during the transfer of the data.

10. A system (102) for transferring data from one storage to another storage in a system (102), comprising:
a transfer AI agent configured to:
one or more Machine Learning (ML)/Artificial Intelligence (AI) models and data associated with the one or more ML/AI models to be transferred to the other storage selected by the transfer AI agent;
organize the one or more ML/AI models and data to be transferred to the other storage;
abstract relevant information from the one or more ML/AI models and the data, wherein the relevant information is encrypted; and
apply one or more obfuscation techniques on the encrypted relevant information, wherein the encrypted relevant information is transferred to the other storage.

11. The system according to claim 10, wherein the one or more obfuscation techniques comprises intentionally making the data unintelligible, preventing third parties from one or more of generating sensitive information and deducing sensitive information.

12. The system according to claim 10, wherein the transfer AI agent is configured to:
maintain one or more detailed logs corresponding to a transfer of the one or more ML/AI models and the data for monitoring the one or more ML/AI models and the data, auditing the one or more ML/AI models and the data, and troubleshooting.

13. The system according to claim 10, wherein the one or more ML/AI models is one or more of a language model, a 3-Dimensional (3D) model, an image model, 3D mannerisms, a voice model including tonal voices and the data comprises one or more documents, information associated with one or more artificial intelligence (AI) models and/or one or more machine learning (ML) models trained for making predictions tailored to individual users or specific use cases, one or more user interactions with the one or more ML/AI models, learned knowledge based on the one or more user interaction, and one or more databases.

14. The system according to claim 10, wherein the transfer AI agent is configured to organize the one or more ML/AI models and the data by:
categorizing the one or more ML/AI models and the data into a plurality of categories, further wherein the plurality of categories comprises one or more facts having immutable data points representing specific events or user attributes, one or more inferences derived by one or more AI agents based on factual data and an observed behaviour, one or more patterns and tendencies observed from one or more user interactions with one or more system or the one or more AI agents; and
structuring the one or more ML/AI models and the data based on the plurality of categories.

15. The system according to claim 10, wherein the transfer AI agent is configured to abstract the data by retaining sensitive information from the one or more ML/AI models and the data for the transfer to minimize one or more attack surfaces in the one or more ML/AI models and the data during the transfer.

16. The system according to claim 10, wherein the transfer AI agent is configured to:
merge one or more common data points in the one or more ML/AI models and the data originating from a plurality of interactions between a user and one or more AI agents; and
aggregate behavioral data from one or more touchpoints to form a holistic view of the data prior to the transfer of the one or more ML/AI models and the data.

17. The system according to claim 10, wherein the transfer AI agent is configured to:
update a user profile associated with a user by collecting one or more new data points from a plurality of AI agents interacting with the user, wherein the one or more new data points is categorized into a plurality of categories.

18. The system according to claim 10, wherein the transfer AI agent is configured to:
perform a validation check on the one or more ML/AI models and the data to ensure that the one or more ML/AI models and the data is not corrupted, and the one or more ML/AI models and the data is meeting a predefined standard prior to the transfer; and
package the one or more ML/AI models and the data with metadata/scripts facilitating one or more of an immediate fine-tuning, a subsequent fine-tuning, and a training to be done during the transfer of the data.

19. A non-transitory machine-readable medium including data, which when used by a system for transferring data from one storage to another storage, causes the system to perform instructions that cause the system to perform operations comprising:
identifying, by a transfer AI agent, one or more Machine Learning (ML)/Artificial Intelligence (AI) models and data associated with the one or more ML/AI models to be transferred to the other storage selected by the transfer AI agent;
organizing, by the transfer AI agent, the one or more ML/AI models and data to be transferred to the other storage;
abstracting, by the transfer AI agent, relevant information from the one or more ML/AI models and the data, wherein the relevant information is encrypted; and
applying, by the transfer AI agent, one or more obfuscation techniques on the encrypted relevant information, wherein the encrypted relevant information is transferred to the other storage.
